(19) United States
(12) Patent Application Publication
(10) Pub. No.: US 2025/0291938 A1
(43) Pub. Date: Sep. 18, 2025

(54) VULNERABILITY ANALYSIS SYSTEM AND VULNERABILITY ANALYSIS METHOD

(71) Applicant: Panasonic Automotive Systems Co., Ltd., Kanagawa (JP)

(72) Inventors: Kotone TOMIIE, Osaka (JP); Yusuke NEMOTO, Hyogo (JP); Hiroyuki WADA, Kyoto (JP); Hatsuho AOSHIMA, Osaka (JP)

(73) Assignee: Panasonic Automotive Systems Co., Ltd., Kanagawa (JP)

(21) Appl. No.: 19/076,561

(22) Filed: Mar. 11, 2025

(30) Foreign Application Priority Data
Mar. 13, 2024 (JP) 2024-039485

(51) Int. Cl. G06F 21/57

(52) U.S. Cl. CPC G06F 21/577; G06F 2221/034

(57) ABSTRACT

A vulnerability analysis system includes classification storage that stores classification information indicating types of assets included in a vehicle on an asset-by-asset basis; a classification identifier that obtains design information indicating an asset included in an analysis target item, and refers to the classification information to identify a type of the asset indicated in the design information; an applicability determiner that determines whether each of one or more first vulnerabilities preliminarily associated with the type identified is applicable to the analysis target item; and an outputter that outputs an analysis result report indicating a determination result obtained by the applicability determiner. The types indicated in the classification information include one or more in-vehicle security-related types.

### CROSS REFERENCE TO RELATED APPLICATION

The present application is based on and claims priority of Japanese Patent Application No. 2024-039485 filed on Mar. 13, 2024.

### FIELD

The present disclosure relates to a vulnerability analysis system and others for analyzing a vulnerability of an analysis target item.

### BACKGROUND

For example, Patent Literature (PTL) 1 discloses a vulnerability evaluation apparatus as a vulnerability analysis system. Such vulnerability evaluation apparatus calculates, for each component of a product, a level of threat to a security hole, on the basis of the asset value, and determines the priority order of a security countermeasure to be taken. Information indicating the asset value and the security hole is stored in a holding unit for each component of the product. This vulnerability evaluation apparatus also includes an attack map holding unit that stores an attack map in which the names of components that form attack paths are associated with vulnerability information corresponding to the names of the components. The vulnerability evaluation apparatus further includes a security countermeasure classification holding unit that stores, for each security countermeasure, a defense target component associated with a coefficient that numerically indicates the effects of the countermeasure. In addition, the vulnerability evaluation apparatus sets an evaluation value of the vulnerability on the basis of a calculation result of multiplying the asset value by the degree of difficulty of attack to the security hole.

### CITATION LIST

### Patent Literature

PTL 1: Japanese Patent No. 6995726

### SUMMARY

However, the above vulnerability evaluation apparatus of PTL 1 can be improved upon.

In view of this, the present disclosure provides a vulnerability analysis system and others capable of improving upon the above related art.

The vulnerability analysis system according to an aspect of the present disclosure includes: classification storage that stores classification information indicating types of assets in a vehicle on an asset-by-asset basis; a classification identifier that obtains design information indicating an asset included in an analysis target item, and refers to the classification information to identify a type of the asset indicated in the design information; an applicability determiner that determines whether each of one or more first vulnerabilities preliminarily associated with the type identified is applicable to the analysis target item; and an outputter that outputs an analysis result report indicating a determination result obtained by the applicability determiner, wherein the types indicated in the classification information include one or more in-vehicle security-related types.

Note that such general or specific aspect may be implemented using a device, a method, an integrated circuit, a computer program, or a computer-readable recording medium such as a CD-ROM, or any combination of devices, methods, integrated circuits, computer programs, or computer-readable recording media. The recording media may be non-transitory recording media.

The vulnerability analysis system of the present disclosure is capable of improving upon the above related art.

Further merits and/or advantageous effects in one aspect of the present disclosure will become apparent from the following description and drawings. These merits and/or advantageous effects are provided by the elements described in the following embodiment, description, and drawings. However, not all of such elements are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing an example of the configuration of a vulnerability analysis system in an embodiment.

FIG. 2 is a diagram showing an example of a screen for generating design information in the embodiment.

FIG. 3 is a diagram for describing an example of the processing performed by a classification identifier and an applicability determiner in the embodiment.

FIG. 4 is a diagram for describing an example of the processing performed by the applicability determiner in the embodiment.

FIG. 5 is a diagram showing an example of the configuration of a priority deriver in the embodiment.

FIG. 6 is a diagram for describing the processing performed by a first priority deriver in the embodiment.

FIG. 7 is a diagram for describing the processing performed by a second priority deriver in the embodiment.

FIG. 8 is a diagram for describing the processing performed by a third priority deriver in the embodiment.

FIG. 9 is a diagram for illustratively describing the determination of risk values and other processing performed by a threat analysis system.

FIG. 10 is a diagram showing an example of an analysis result report outputted from an outputter in the embodiment.

FIG. 11 is a flowchart showing an example of a series of processing operations performed by the classification identifier, the applicability determiner, and a reason deriver in the embodiment.

FIG. 12 is a flowchart showing an example of the processing operation performed by the priority deriver in the embodiment.

### DESCRIPTION OF EMBODIMENT

The vulnerability analysis system according to a first aspect of the present disclosure includes: classification storage that stores classification information indicating types of assets in a vehicle on an asset-by-asset basis; a classification identifier that obtains design information indicating an asset included in an analysis target item, and refers to the classification information to identify a type of the asset indicated in the design information; an applicability determiner that determines whether each of one or more first vulnerabilities preliminarily associated with the type identified is applicable to the analysis target item; and an outputter that outputs an analysis result report indicating a determination result obtained by the applicability determiner,

wherein the types indicated in the classification information include one or more in-vehicle security-related types. Note that each of the first vulnerabilities is a vulnerability identified by, for example, a common weakness enumeration (CWE)-ID, and also referred to as “vulnerability type”.

With this, the types indicated by the classification information include one or more in-vehicle security-related types. For this reason, the case can occur where an in-vehicle security-specific type is identified as an asset type. In such a case, it is determined whether the first vulnerability specific to in-vehicle security is applicable to the analysis target item. This enables the determination on the first vulnerability from the standpoint specific to in-vehicle security, thereby improving the accuracy of vulnerability analysis. Specifically, the above vulnerability evaluation apparatus of PTL 1 has a problem in that the accuracy of vulnerability analysis is low. However, the present disclosure is capable of improving the accuracy of vulnerability analysis.

Also, in the vulnerability analysis system according to a second aspect, the classification storage may include: first classification storage that stores first classification information associating each of the one or more in-vehicle security-related types with one or more assets classified into the in-vehicle security-related type; and second classification storage that stores second classification information associating each of one or more security-related types not limited to in-vehicle security with one or more assets classified into the security-related type. Note that the second aspect may be dependent on the first aspect.

With this, it is possible to make a determination on the first vulnerability on the basis of the standpoint specific to in-vehicle security and from the standpoint of general security. With this, it is possible to more effectively improve the accuracy of vulnerability analysis.

Also, the vulnerability analysis system according to a third aspect may further include a priority deriver that derives, for each applicable vulnerability, a priority of a mitigation to be taken against the applicable vulnerability as a response priority, the applicable vulnerability being one of the one or more first vulnerabilities that has been determined to be applicable to the analysis target item. Note that the third aspect may be dependent on the first aspect or the second aspect.

With this, the response priority is derived for each of the plurality of first vulnerabilities determined to be applicable to the analysis target item, that is, a plurality of applicable vulnerabilities. Such plurality of applicable vulnerabilities can include an applicable vulnerability specific to in-vehicle security. In such a case, it is possible to derive a higher response priority for such applicable vulnerability specific to in-vehicle security than for other applicable vulnerabilities. Alternatively, it is also possible to derive the response priority for such applicable vulnerability specific to in-vehicle security, using a method specific to in-vehicle security. With this, it is possible to derive the response priority appropriate for each of the plurality of applicable vulnerabilities, thereby preventing the lack of or delay in taking mitigations against those applicable vulnerabilities. Further, even when a large number of applicable vulnerabilities is present, it is possible to appropriately derive response priorities for such applicable vulnerabilities. This enables the mitigations against these applicable vulnerabilities to be taken in appropriate order.

Also, in the vulnerability analysis system according to a fourth aspect, the priority deriver may derive the response priority of the applicable vulnerability, using at least one of: (a) an impact of the applicable vulnerability on traveling of the vehicle that includes the analysis target item; (b) an actual number of second vulnerabilities found in a plurality of vehicles in past, the second vulnerabilities belonging to the applicable vulnerability; or (c) an actual person-hour spent to take the mitigation against the applicable vulnerability in past. Note that the fourth aspect may be dependent on the third aspect that is dependent on the first aspect or the second aspect. Also, the traveling of the vehicle corresponds to the vehicle functions of running, turning, stopping, etc. Also, the second vulnerability is a vulnerability identified by, for example, a common vulnerabilities and exposures (CVE)-ID.

With this, it is possible to derive the response priority in a highly accurate manner from the standpoint of the impacts of the applicable vulnerability on the traveling of the vehicle, the actual number of second vulnerabilities, the actual person-hours spent to take the mitigation against the applicable vulnerability, etc.

Also, in the vulnerability analysis system according to a fifth aspect, the priority deriver may derive the response priority of the applicable vulnerability, using a degree of impact that is a magnitude of an impact of the asset on an architecture, the asset being included in the analysis target item. Note that the fifth aspect may be dependent on the third aspect that is dependent on the first aspect or the second aspect, or may be dependent on the fourth aspect.

With this, it is possible to derive the response priority in a highly accurate manner from the standpoint of the magnitude of the impact on the architecture.

Also, in the vulnerability analysis system according to a sixth aspect, the priority deriver may derive the response priority of the applicable vulnerability, using a level of impact of an attack to the asset on the analysis target item, a level of attack feasibility that is feasibility of the attack to the asset, and a total number of attack paths to the asset. Note that the sixth aspect may be dependent on the third aspect that is dependent on the first aspect or the second aspect, or may be dependent on the fourth aspect or the fifth aspect.

With this, it is possible to derive the response priority in a highly accurate manner from the standpoint of the level of impact, the level of attack feasibility, and the attack path number.

Also, the vulnerability analysis system according to a seventh aspect may further include a reason deriver that derives a reason why a first vulnerability determined not to be applicable to the analysis target item, among the one or more first vulnerabilities, is not applicable to the analysis target item. Note that the seventh aspect may be dependent on any one of the first aspect to the sixth aspect.

With this, the reason for non-applicability is derived, thereby ensuring the reliability of the determination result obtained by the applicability determiner.

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps, etc. shown in the following exemplary embodiment are mere examples, and therefore do not limit the scope of the present disclosure. Therefore, among the elements in the following exemplary embodiment, those not recited in any one of the independent claims are described as optional elements.

Also note that the drawings are schematic diagrams, and thus they are not always exactly illustrated. Also, the same elements are assigned the same reference marks throughout the drawings.

### Embodiment

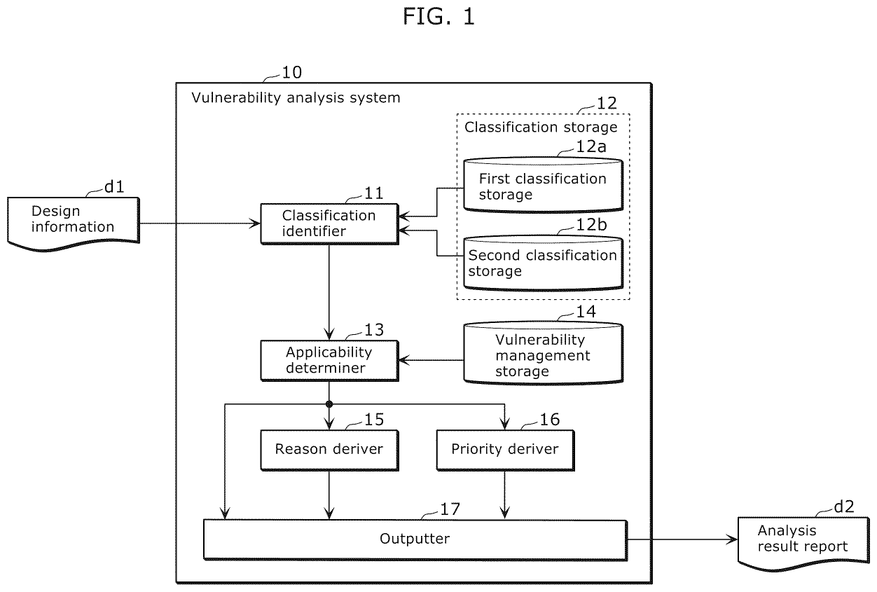

FIG. 1 is a diagram showing an example of the configuration of a vulnerability analysis system in the present embodiment.

Vulnerability analysis system 10 in the present embodiment is, for example, a system for analyzing a vulnerability of information security in an analysis target item included in a vehicle. Stated differently, vulnerability analysis system 10 obtains design information d1 of the analysis target item, and analyzes, for each of one or more assets indicated in design information d1, the vulnerability of such asset. Vulnerability analysis system 10 then outputs analysis result report d2 as information indicating the results of such vulnerability analysis.

Note that the analysis target item and assets may be, for example, functions implemented by a program. The analysis target item may also be, for example, an electronic control unit (ECU) mounted on a vehicle. Vulnerability analysis system 10 may also be, for example, a system compliant with the regulations of International Organization for Standardization (ISO)/Society of Automotive Engineers (SAE) 21434.

Such vulnerability analysis system 10 includes classification identifier 11, classification storage 12, applicability determiner 13, vulnerability management storage 14, reason deriver 15, priority deriver 16, and outputter 17.

Classification storage 12 is a recording medium that stores, for each asset included in the vehicle, classification information indicating the type of such asset. Note that the classification information can also be said to be information indicating the results of classifying the assets. In the present embodiment, classification storage 12 includes first classification storage 12a and second classification storage 12b.

First classification storage 12a is a recording medium that stores first classification information indicating the results of classifying a plurality of assets from the standpoint specific to vehicle. More specifically, the first classification information associating each of one or more in-vehicle security-related types with one or more assets classified into such type. Stated differently, the first classification information classifies the plurality of assets from the standpoint specific to vehicle, in-vehicle, or in-vehicle security.

Second classification storage 12b is a recording medium that stores second classification information indicating the results of classifying a plurality of assets from the standpoint of general security. More specifically, the second classification information associating each of one or more security-related types not limited to in-vehicle security with one or more assets classified into such type.

Stated differently, the classification information in the present embodiment includes the first classification information and the second classification information. The plurality of types indicated by the classification information include one or more in-vehicle security-related types. Note that in-vehicle security is, for example, security in an information processing system or a program mounted on the vehicle.

Vulnerability management storage 14 is a recording medium that stores vulnerability management information associating each of the plurality of types with one or more first vulnerabilities applicable to such type.

In the present embodiment, each of the first vulnerabilities is a vulnerability identified by a CWE-ID, which is information for identifying the category or type of the vulnerability. Stated differently, in the present embodiment, each of the first vulnerabilities is a highly abstract vulnerability, and is also referred to as “vulnerability type”. More specifically, CWE is a common standard, disclosed by The MITRE Corporation, for identifying the types of vulnerabilities in software security. CWE-IDs are classified in accordance with, for example, View or Category.

The recording media such as first classification storage 12a, second classification storage 12b, vulnerability management storage 14, etc. may each be, for example, a hard disk drive, a random-access memory (RAM), a read-only memory (ROM), or a semiconductor memory. Also, these recording media may either be volatile or non-volatile.

Classification identifier 11 obtains design information d1 indicating the assets included in the analysis target item. Classification identifier 11 then refers to the classification information described above (i.e., the first classification information and the second classification information) to identify the type of each of the assets indicated by such design information d1. Note that classification identifier 11 may identify a plurality of types for a single asset.

Applicability determiner 13 determines whether each of one or more first vulnerabilities that are preliminarily associated with the type identified by classification identifier 11 is applicable to the analysis target item. Stated differently, applicability determiner 13 refers to the vulnerability management information in vulnerability management storage 14 to search, from such vulnerability management information, for each of the one or more first vulnerabilities that are preliminarily associated with the type identified by classification identifier 11. Applicability determiner 13 then determines whether each of the one or more first vulnerabilities that have been found by the search is applicable to the analysis target item. Applicability determiner 13 outputs determination result information indicating the results of such determination to reason deriver 15, priority deriver 16, and outputter 17.

Upon obtaining the determination result information from applicability determiner 13, reason deriver 15 derives the reason why a first vulnerability determined not to be applicable to the analysis target item, among the one or more first vulnerabilities, is not applicable to the analysis target item, on the basis of the determination result information. A first vulnerability determined to be applicable to the analysis target item, among the one or more first vulnerabilities, is hereinafter also referred to as “applicable vulnerability”. Reason deriver 15 then outputs, to outputter 17, reason information indicating the reason that has been derived.

Priority deriver 16 derives, for each of the first vulnerabilities determined to be applicable to the analysis target item, that is, the applicable vulnerabilities, the priority of the mitigation to be taken against such applicable vulnerability, as the response priority. Priority deriver 16 then outputs, to outputter 17, priority information indicating the response priorities that have been derived. Priority deriver 16 in the present embodiment derives the response priorities of the applicable vulnerabilities even when the analysis target item includes a large number of assets and a large number of applicable vulnerabilities corresponding to these assets is present.

Outputter 17 obtains the determination result information from applicability determiner 13, the reason information from reason deriver 15, and the priority information from priority deriver 16. Outputter 17 then outputs analysis result report d2 including the determination result information, the reason information, and the priority information. Stated differently, analysis result report d2 shows the determination results obtained by applicability determiner 13.

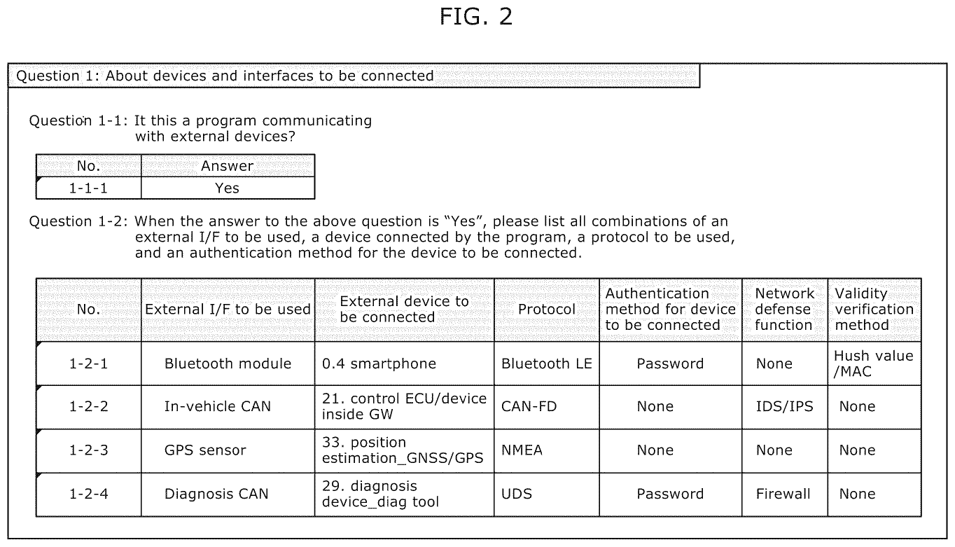

FIG. 2 is a diagram showing an example of a screen for generating design information d1.

For example, a computer displays, on the display, the screen shown in FIG. 2. Such screen is a screen for asking a user questions and receiving answers from the user. The questions are about the analysis target item. The computer receives answers from the user via such screen, thereby generating design information d1 that indicates one or more assets corresponding to the answers, and outputting, to classification identifier 11, design information d1 that has been generated.

More specifically, the screen shows question 1-1 “Is this a program communicating with external devices?” When the answer to this question is “Yes”, the screen further shows another question 1-2 “Please list all combinations of an external interface to be used, a device to be connected by the program, a protocol to be used, and an authentication method of the device to be connected”. The external interface is also written as “external I/F”.

The computer receives “Yes” as the answer to question 1-1, in response to an input operation performed by the user, and further receives the answer to question 1-2. When providing the answer to question 1-2, the user selects one alternative for each of the items, from a plurality of alternatives. Such items include “external I/F to be used”, “external device to be connected”, “protocol”, “authentication method for external device to be connected”, “network defense function”, “validity verification method”, etc. The user selects the answer to each of these items. For example, the user selects “in-vehicle CAN” as the answer to the item “external I/F to be used”, selects “control ECU/device inside GW” as the answer to the item “external device to be connected”, and selects “CAN-FD” as the answer to the item “protocol”. The user further selects “none” for the item “authentication method for device to be connected”, selects “IDS/IPS for the item “network defense function”, and selects “none” for the “validity verification method”. Through this, one combination of “in-vehicle CAN”, “control ECU/device inside GW”, “CAN-FD”, “none”, “IDS/IPS”, and “none” is received as the answer to question 1-2. Stated differently, the answer indicated by answer number “1-2-2” is received.

The computer generates design information d1 on the basis of the answers received in the above manner.

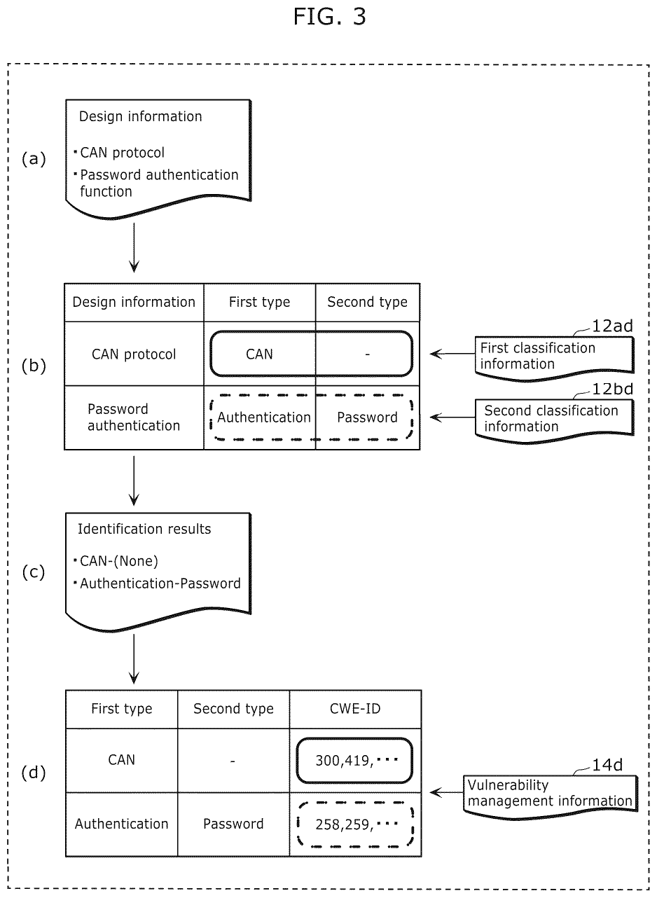

FIG. 3 is a diagram for describing an example of the processing performed by classification identifier 11 and applicability determiner 13.

Classification identifier 11 obtains design information d1 described above. As shown in (a) in FIG. 3, such design information d1 indicates, for example, “CAN protocol” and “password authentication function” as assets. Note that CAN stands for “controller area network”. Also, “CAN protocol” and “password authentication function” are examples of the assets that are based on the answers indicated as the answer numbered “1-2-2” and the answer numbered “1-2-4”, respectively, shown in FIG. 2.

Classification identifier 11 searches for the asset “CAN protocol” from first classification information 12ad in first classification storage 12a and second classification information 12bd in second classification storage 12b. In this case, the asset “CAN protocol” is indicated in first classification information 12ad. As such, as shown in (b) in FIG. 3, classification identifier 11 identifies the type associated with the asset “CAN protocol” in first classification information 12ad. Such type is an in-vehicle security-related type or an in-vehicle security-specific type. The type also includes, for example, a first type and a second type. The second type may be a type resulting from further classifying the first type. Alternatively, the second type may be a type independent of the first type. In an example shown in FIG. 3, classification identifier 11 identifies “CAN” as the first type and identifies “-” as the second type as types associated with the asset “CAN protocol”. Note that “-” indicates that the second type is not present, and is also written as “(none)”.

Similarly, classification identifier 11 searches for the asset “password authentication” from first classification information 12ad in first classification storage 12a and second classification information 12bd in second classification storage 12b. In this case, the asset “password” is indicated in second classification information 12bd. As such, as shown in (b) in FIG. 3, classification identifier 11 identifies the type associated with the asset “password authentication” in second classification information 12bd. Such type is a security-related type not limited to in-vehicle security, that is, a type related to general security. In an example in FIG. 3, classification identifier 11 identifies “authentication” as the first type and identifies “password” as the second type as types associated with the asset “password authentication”.

With this, as shown in (c) in FIG. 3, a combination of the first type “CAN” and the second type “(none)” is obtained as the identification result for the asset “CAN protocol”. Further, a combination of the first type “authentication” and the second type “password” is obtained as the identification result for the asset “password authentication”.

Subsequently, as shown in (d) in FIG. 3, applicability determiner 13 refers to vulnerability management information 14d in vulnerability management storage 14 to search for one or more first vulnerabilities that are associated with the identified combinations of the first type and the second type. Stated differently, the applicability determiner searches for one or more CWE-IDS. More specifically, in vulnerability management information 14d, CWE-IDs “300”, “419”, etc. are associated with the combination of the first type “CAN” and the second type “-”. Further, in vulnerability management information 14d, CWE-IDs “258”, “259”, etc. are associated with the combination of the first type “authentication” and the second type “password”. Applicability determiner 13 thus searches for CWE-IDs “300”, “419”, etc., for the combination of the first type “CAN” and the second type “-”. Applicability determiner 13 further searches for CWE-IDs “258”, “259”, etc. for the combination of the first type “authentication” and the second type “password”.

Note that, in vulnerability management information 14d, one or more CWE-IDs may be associated with each of the first type and the second type. In this case, applicability determiner 13 refers to vulnerability management information 14d to search for one or more CWE-IDs associated with the first type, and further searches for one or more CWE-IDs associated with the second type.

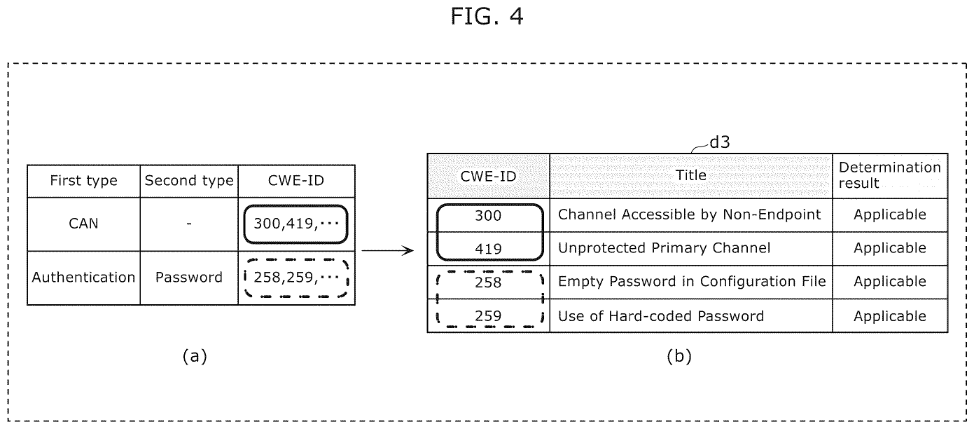

FIG. 4 is a diagram for describing an example of the processing performed by applicability determiner 13.

After finding one or more CWE-IDs by the search as shown in (a) in FIG. 4, applicability determiner 13 determines whether each of such one or more CWE-IDs is applicable to the analysis target item as shown in (b) in FIG. 4. Applicability determiner 13 may perform such determination, for example, with reference to a predetermined table, or in response to an input operation performed by the user. Applicability determiner 13 then generates and outputs determination result information d3 indicating the determination result on each of such one or more CWE-IDs. Determination result information d3 may indicate, for each CWE-ID, the title of such CWE-ID.

As described above, in the present embodiment, the plurality of types indicated by the classification information including first classification information 12ad and second classification information 12bd include one or more in-vehicle security-related types. For this reason, the case can occur where an in-vehicle security-specific type is identified as an asset type. In such a case, it is determined whether the first vulnerability specific to in-vehicle security is applicable to the analysis target item. This enables the determination on the first vulnerability from the standpoint specific to in-vehicle security, thereby improving the accuracy of vulnerability analysis.

Also, in the present embodiment, the classification information includes first classification information 12ad and second classification information 12bd. This enables the determination on the first vulnerability from the standpoint specific to in-vehicle security and from the standpoint of general security. With this, it is possible to more effectively improve the accuracy of vulnerability analysis.

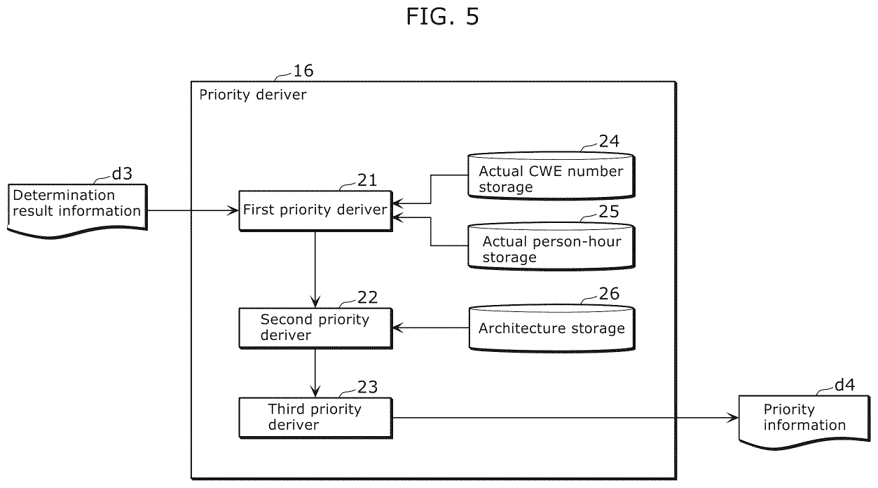

FIG. 5 is a diagram showing an example of the configuration of priority deriver 16.

Priority deriver 16 in the present embodiment includes first priority deriver 21, second priority deriver 22, third priority deriver 23, actual CWE number storage 24, actual person-hour storage 25, and architecture storage 26.

Actual CWE number storage 24 is a recording medium that stores actual CWE number information. The actual CWE number information indicates, for each CWE-ID, the actual number, which is the number of CVE-IDs belonging to such CWE-ID have been assigned as in-vehicle CVEs in the past year. Note that a vulnerability identified by a CVE-ID is also referred to as “second vulnerability”.

Actual person-hour storage 25 is a recording medium that stores actual person-hour information. The actual person-hour information indicates, for each CWE-ID, the actual person-hours spent to take the mitigation against the vulnerability (i.e. first vulnerability) identified by such CWE-ID.

Architecture storage 26 is a recording medium that stores architecture information. The architecture information indicates, for each architecture type, the degree of impact on an architecture of such type.

The recording media such as actual CWE number storage 24, actual person-hour storage 25, architecture storage 26, etc., may each be, for example, a hard disk drive, a RAM, a ROM, or a semiconductor memory. Also, these recording media may either be volatile or non-volatile.

First priority deriver 21 obtains determination result information d3 indicating the determination results obtained by applicability determiner 13. Determination result information d3 indicates, for example, one or more CWE-IDs and the determination result indicating whether each of the CWE-IDs is applicable, as shown in (b) in FIG. 4. Note that a CWE-ID determined to be applicable is hereinafter also referred to as “applicable CWE-ID”, and a vulnerability identified by an applicable CWE-ID (i.e., first vulnerability) is hereinafter also referred to as “applicable vulnerability”.

Subsequently, first priority deriver 21 derives, for each of the applicable CWE-IDs, that is, for each of the applicable vulnerabilities identified by the applicable CWE-IDs, the priority of the mitigation to be taken against such applicable vulnerability, as a first priority. In so doing, first priority deriver 21 derives the first priority of each of the applicable CWE-IDs, on the basis of the actual CWE number information in actual CWE number storage 24 and the actual person-hour information in actual person-hour storage 25. In addition, first priority deriver 21 outputs, to second priority deriver 22, first priority information indicating the first priority derived for each of the applicable CWE-IDs.

Second priority deriver 22 derives, for each of the applicable CWE-IDs, that is, for each of the applicable vulnerabilities identified by the applicable CWE-IDs, the priority of the mitigation to be taken against such applicable vulnerability, as a second priority. For example, upon obtaining the first priority information from first priority deriver 21, second priority deriver 22 identifies the first priority of each of the applicable CWE-IDs indicated in such first priority information. Second priority deriver 22 further derives the second priority of each of the applicable CWE-IDs, using the applicable CWE-ID, the first priority of the applicable CWE-ID, and the architecture information in architecture storage 26. Second priority deriver 22 then outputs, to third priority deriver 23, second priority information indicating the second priority derived for each of the applicable CWE-IDs.

Third priority deriver 23 derives, for each of the applicable CWE-IDs, that is, for each of the applicable vulnerabilities identified by the applicable CWE-IDs, the priority of the mitigation to be taken against such applicable vulnerability, as a third priority. For example, upon obtaining the second priority information from second priority deriver 22, third priority deriver 23 identifies the second priority of each of the applicable CWE-IDs indicated in such second priority information. Third priority deriver 23 further derives the third priority of each of the applicable CWE-IDs, using the risk value of the asset, the second priority of the applicable CWE-ID, and the number of attack paths to the asset. Third priority deriver 23 then outputs priority information d4 indicating, as the response priority, the third priority derived for each of the applicable CWE-IDs.

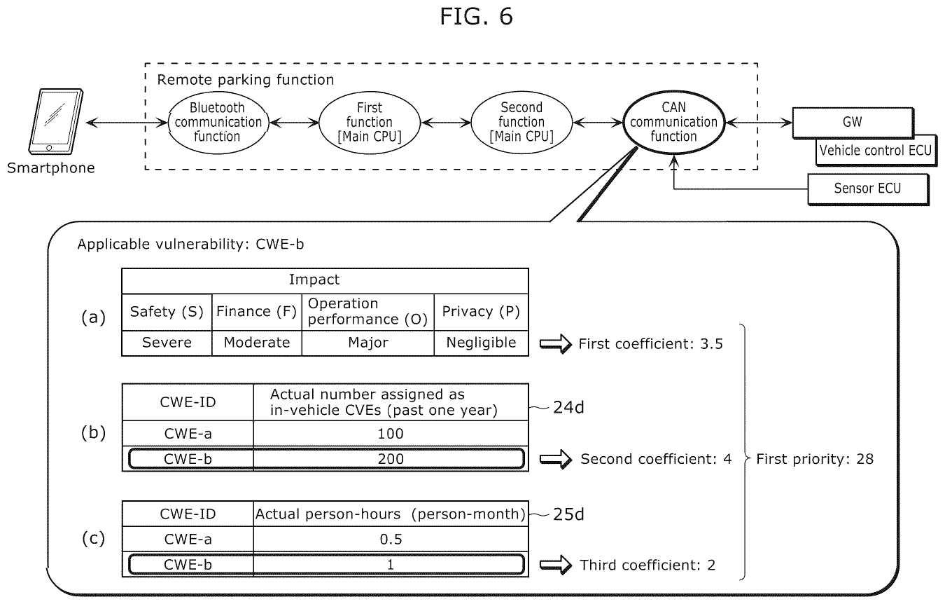

FIG. 6 is a diagram for describing the processing performed by first priority deriver 21.

As shown in FIG. 6, the analysis target item is, for example, the remote parking function of the vehicle. The analysis target item includes, as the assets, a Bluetooth (registered trademark) communication function, a first function, a second function, and a CAN communication function. Of these assets, the asset “CAN communication function” has the first vulnerability (more specifically, vulnerability type) that is identified by CWE-ID “CWE-b”. Note that “CWE-b” is an applicable CWE-ID, and the foregoing first vulnerability is an applicable vulnerability.

First priority deriver 21 receives levels of impact on the vehicle exerted by the applicable vulnerability identified by the applicable CWE-ID, for example, in response to an input operation performed by the user. Such impact is represented by, for example, the safety level(S), the financial level (F), the operational level (O), and the privacy level (P). Stated differently, the impact levels are represented by SFOP. These levels are represented in a four-point scale, which are, for example, “Severe”, “Major”, “Moderate”, “Negligible”, etc., in descending level order.

As shown in (a) in FIG. 6, for example, first priority deriver 21 receives “Severe” as the safety level(S) and “Moderate” as the financial level (F). First priority deriver 21 further receives “Major” as the operational level (O) and receives “Negligible” as the privacy level (P). The safety level(S) “Severe” is the level that causes life-threatening damage or fatal injuries. The financial level (F) “Moderate” is the level that causes minor damage below the price of the vehicle. The operational level (O) “Major” is the level that causes the loss of important vehicle functions. The privacy level (P) “Negligible” is the level that does not affect the functions or performance of the vehicle.

In the foregoing example, first priority deriver 21 receives SFOP for the applicable CWE-ID, in response to an input operation performed by the user, but first priority deriver 21 may receive such SFOP with reference to a predetermined table. In such table, SFOP is defined for each CWE-ID.

Upon receiving the SFOP, first priority deriver 21 derives a first coefficient for the applicable vulnerability identified by the CWE-ID “CWE-b”, on the basis of the impacts of such applicable vulnerability on the safety and traveling of the vehicle, among the impacts of the SFOP. The impact on the safety of the vehicle is represented by the safety level(S). The impact on the traveling of the vehicle is the impact on the vehicle functions of running, turning, and stopping, and is represented by the operational level (O). In view of this, first priority deriver 21 derives the first coefficient “3.5” from the safety level(S) “Severe” and the operational level (O) “Major”. Note that a combination of the safety level(S) and the operational level (O), and the first coefficient may be preliminarily associated with each other. Stated differently, first priority deriver 21 searches, from a table showing each of a plurality of combinations and the first coefficient associated with such combination, for the first coefficient corresponding to the received combination of the safety level(S) and the operational level (O). Through this, the first coefficient is derived.

In the foregoing example, first priority deriver 21 derives the first coefficient on the basis of the combination of the safety level(S) and the operational level (O), but first priority deriver 21 may also derive the first coefficient on the basis of only one of the safety level(S) or the operational level (O). For example, first priority deriver 21 may derive the first coefficient on the basis of only the safety level(S). Alternatively, first priority deriver 21 may derive the first coefficient, using all levels of SFOP.

Next, as shown in (b) in FIG. 6, first priority deriver 21 refers to actual CWE number information 24d stored in actual CWE number storage 24. As described above, actual CWE number information 24d indicates, for each CWE-ID, the actual number, which is the number of CVE-IDs belonging to such CWE-ID have been assigned as in-vehicle CVEs in the past year. Stated differently, actual CWE number information 24d indicates the number of vulnerabilities identified by a plurality of in-vehicle CVEs belonging to the CWE-IDs (i.e., second vulnerabilities) that have been found in the immediate past year in the in-vehicle industry or the vehicle industry. When the applicable vulnerability is the first vulnerability identified by the CWE-ID “CWE-b”, first priority deriver 21 searches for the CWE-ID “CWE-b” from actual CWE number information 24d. First priority deriver 21 then identifies the actual number “200” associated with such CWE-ID “CWE-b” in actual CWE number information 24d. First priority deriver 21 further derives a second coefficient that is larger as the actual number is greater. For example, first priority deriver 21 derives the second coefficient “4” from the actual number “200”. Note that the relationship between the actual number and the second coefficient may be expressed by a function or in a tabular form.

Next, as shown in (c) in FIG. 6, first priority deriver 21 refers to actual person-hour information 25d stored in actual person-hour storage 25. As described above, actual person-hour information 25d indicates, for each CWE-ID, the actual person-hours spent to take the mitigation against the first vulnerability identified by such CWE-ID. When the applicable vulnerability is the first vulnerability identified by the CWE-ID “CWE-b,” first priority deriver 21 searches for the CWE-ID “CWE-b” from actual person-hour information 25d. First priority deriver 21 then identifies the actual person-hour “1” associated with the CWE-ID “CWE-b” in actual person-hour information 25d. First priority deriver 21 further derives a third coefficient that is larger as the actual person-hours is greater. For example, first priority deriver 21 derives the third coefficient “2” from the actual person-hour “1”. Note that the relationship between the actual person-hours and the third coefficient may be expressed by a function or in a tabular form.

Subsequently, first priority deriver 21 derives the first priority on the basis of the first coefficient, the second coefficient, and the third coefficient. First priority deriver 21 derives the first priority by, for example, multiplying the first coefficient, the second coefficient, and the third coefficient. In the foregoing example, first priority deriver 21 derives the first priority “28” by multiplying the first coefficient “3.5”, the second coefficient “4”, and the third coefficient “2”. Note that, in the foregoing example, multiplication is used to derive the first priority, but an operation or a formula other than multiplication may be used, such as the average of the foregoing three coefficients.

As described above, first priority deriver 21 in the present embodiment derives the first priority of the mitigation to be taken against the applicable vulnerability, on the basis of the first coefficient, the second coefficient, and the third coefficient. Priority deriver 16 in the present embodiment uses such first priority to derive the response priority. Thus, priority deriver 16 in the present embodiment derives the response priority of the applicable vulnerability, using (a) the impacts of the applicable vulnerability on the traveling of the vehicle having the analysis target item, (b) the actual number of the second vulnerabilities belonging to the applicable vulnerability found in a plurality of vehicles in the past, and (c) the actual person-hours spent to take the mitigation against the applicable vulnerability in the past. The impacts described in (a) is the safety level(S) and the operational level (O) described above, the actual number described in (b) is the actual number identified from actual CWE number information 24d, and the actual person-hours described in (c) is the actual person-hours identified from actual person-hour information 25d.

As described above, in the present embodiment, the response priority is derived for each of the plurality of first vulnerabilities determined to be applicable to the analysis target item, that is, a plurality of applicable vulnerabilities. Such plurality of applicable vulnerabilities can include an applicable vulnerability specific to in-vehicle security. In such a case, it is possible to derive a higher response priority for such applicable vulnerability specific to in-vehicle security than for other applicable vulnerabilities. Alternatively, it is also possible to derive the response priority for such applicable vulnerability specific to in-vehicle security, using a method specific to in-vehicle security. With this, it is possible to derive the response priority appropriate for each of the plurality of applicable vulnerabilities, thereby preventing the lack of or delay in taking mitigations against those applicable vulnerabilities. Further, even when a large number of applicable vulnerabilities is present, it is possible to appropriately derive response priorities for such applicable vulnerabilities. This enables the mitigations against these applicable vulnerabilities to be taken in appropriate order.

In the present embodiment, the response priority for each applicable vulnerability is derived using (a), (b), and (c) described above. This enables a highly accurate derivation of the response priority from the standpoint of the impacts of the applicable vulnerability on the traveling of the vehicle, the actual number of second vulnerabilities, the actual person-hours spent to take the mitigation against the applicable vulnerability, etc.

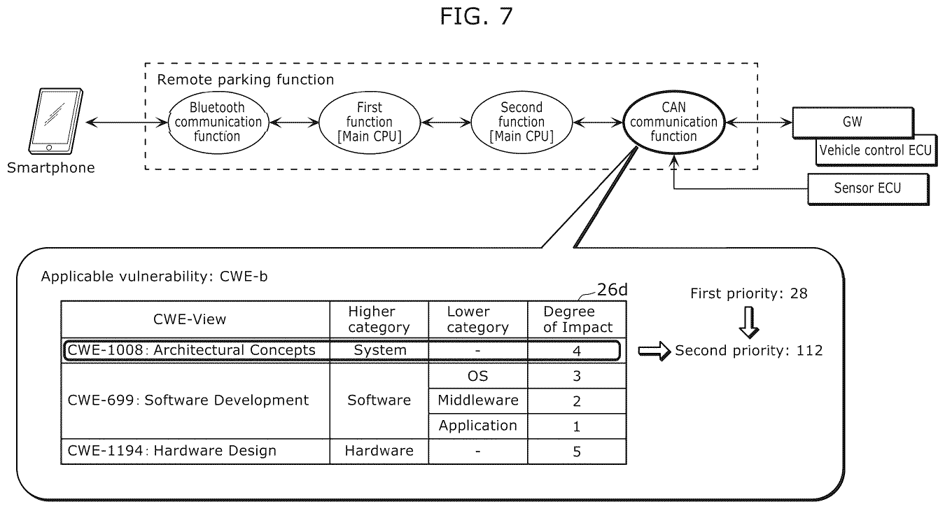

FIG. 7 is a diagram for describing the processing performed by second priority deriver 22.

Second priority deriver 22 refers to architecture information 26d stored in architecture storage 26, as shown in FIG. 7. As described above, architecture information 26d indicates, for each architecture type, the magnitude of the impact on the architecture of such type, as the degree of impact. For example, in architecture information 26d, architecture types are classified into a plurality of higher categories, each of which is further classified into lower categories. Stated differently, an architecture type is formed of a combination of a higher category and a lower category. Stated differently, an architecture type is formed of a major category and a minor category. In architecture information 26d, each of the higher categories is associated with a CWE-View.

When the applicable vulnerability is the first vulnerability identified by the CWE-ID “CWE-b”, second priority deriver 22 identifies the architecture type corresponding to such CWE-ID “CWE-b”. The asset corresponding to the CWE-ID “CWE-b” is the CAN communication function and related to system and software as an architecture type. Second priority deriver 22 thus identifies system and software as the architecture type corresponding to the CWE-ID “CWE-b”. Second priority deriver 22 then identifies, in architecture information 26d, the degree of impact “4” associated with the higher category “system” and the degrees of impact “3, 2, 1” associated with the higher category “software”. Second priority deriver 22 further selects the highest degree of impact “4” from those degrees of impact that have been identified.

Next, second priority deriver 22 derives the second priority, on the basis of the first priority of the applicable CWE-ID “CWE-b” indicated in the first priority information and the degree of impact “4” identified and selected for the applicable CWE-ID “CWE-b”. Second priority deriver 22 derives the second priority by, for example, multiplying the first priority by the degree of impact. In the case of the foregoing example, second priority deriver 22 derives the second priority “112” by multiplying the first priority “28” by the degree of impact “4”. Note that, in the foregoing example, multiplication is used to derive the second priority, but an operation or a formula other than multiplication may be used.

As described above, second priority deriver 22 in the present embodiment derives the second priority of the mitigation to be taken against the applicable vulnerability, on the basis of the degree of impact on the architecture. Also, priority deriver 16 in the present embodiment derives the response priority, using such second priority. Priority deriver 16 in the present embodiment thus derives the response priority of the applicable vulnerability, using the degree of impact, which is the magnitude of the impact on the architecture exerted by the asset included in the analysis target item.

With this, it is possible to derive the response priority in a highly accurate manner from the standpoint of the magnitude of the impact on the architecture.

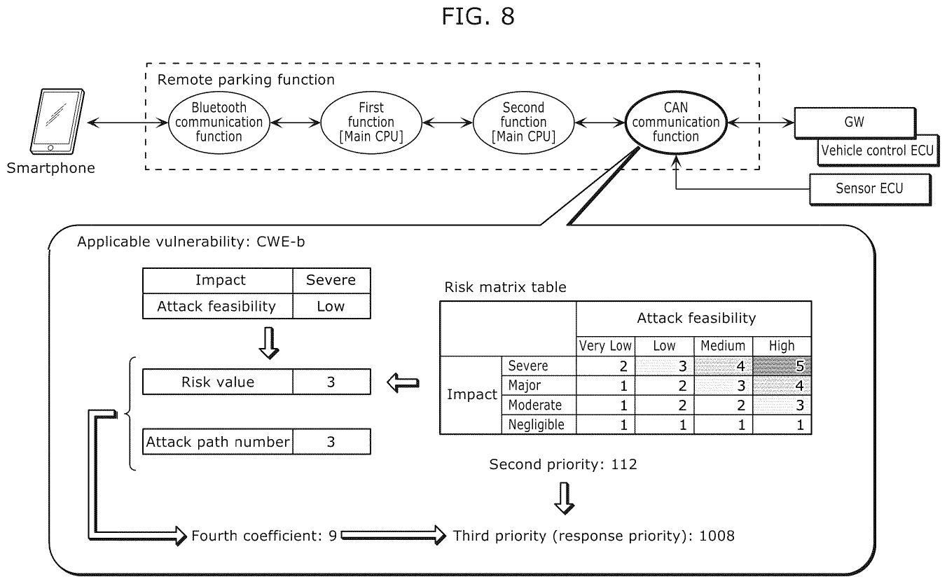

FIG. 8 is a diagram for describing the processing performed by third priority deriver 23.

When the applicable vulnerability is the first vulnerability identified by the CWE-ID “CWE-b”, as shown in FIG. 8, third priority deriver 23 determines the risk value of the asset corresponding to such CWE-ID “CWE-b”, that is, the applicable CWE-ID “CWE-b”. Third priority deriver 23 further derives a fourth coefficient, on the basis of such risk value and the attack path number, which is the number of attack paths to the asset. Third priority deriver 23 then derives a third priority as the response priority, on the basis of the fourth coefficient and the second priority that has been derived by second priority deriver 22.

More specifically, third priority deriver 23 first derives a data flow diagram (DFD) of the analysis target item, on the basis of, for example, design information d1. Note that third priority deriver 23 may derive the DFD, using other information, may obtain the DFD from another system or device, or may derive the DFD on the basis of an input operation performed by the user. The DFD is a diagram showing, for example, the flow of data between external devices such as a smartphone, a gateway (GW), and a sensor EC, and each component included in the remote parking function, which is the analysis target item.

Next, third priority deriver 23 identifies the attack paths to the asset corresponding to the applicable CWE-ID “CWE-b”, on the basis of the DFD. In an example in FIG. 8, the asset is the CAN communication function. The attack paths to the CAN communication function include a first attack path, a second attack path, and a third attack path. As shown in FIG. 8, the first attack path is a path to the CAN communication function from the smartphone, which is located outside of the remote parking function. The second attack path is a path to the CAN communication function from the GW, which is located outside of the remote parking function and connected to the vehicle control ECU. The third attack path is a path to the CAN communication function from the sensor ECU, which is located outside of the remote parking function. The number of attack paths to the CAN communication function from outside of the remote parking function, that is, the attack path number, is “3”. As such, third priority deriver 23 identifies “3” as the attack path number.

Next, third priority deriver 23 determines the risk value for each of the attack paths to the asset corresponding to the applicable CWE-ID “CWE-b” (CAN communication function in an example in FIG. 8). In determining each of the risk values for the asset, third priority deriver 23 uses the level of impact of an attack to the asset on the analysis target item, the level of attack feasibility, which is the feasibility of the attack to the asset via the attack path, and the risk matrix table. Note that the level of impact, the level of attack feasibility, and risk matrix table are defined, for example, by ISO 21434. When the level of impact is “Severe” and the level of attack feasibility is “Low,” for example, third priority deriver 23 searches, from the risk matrix table, for the risk value associated with the level of impact “Severe” and the level of attack feasibility “Low”. Through such a search, third priority deriver 23 determines the risk value “3”. After determining the risk values for the respective attack paths, third priority deriver 23 selects the largest risk value from these risk values. In an example in FIG. 8, “3” is selected as the largest risk value.

Next, third priority deriver 23 derives a fourth coefficient “9” by, for example, multiplying the largest risk value “3” selected in the above manner by the attack path number “3” that has been identified. Third priority deriver 23 further derives the third priority “1108” by, for example, multiplying the fourth coefficient “9” by the second priority “112”. The third priority “1108” is handled as the response priority. Note that, in the foregoing example, multiplication is used to derive the third priority, but an operation or a formula other than multiplication may be used.

As described above, third priority deriver 23 in the present embodiment derives the third priority of the mitigation to be taken against the applicable vulnerability, on the basis of the risk value and the attack path number. The risk value is determined on the basis of the level of impact of the attack to the asset on the analysis target item and the level of attack feasibility to the asset. Also, in the present embodiment, such third priority is handled as the response priority. As such, priority deriver 16 in the present embodiment derives the response priority of the applicable vulnerability, using the level of impact of an attack to the asset on the analysis target item, the level of attack feasibility to the asset, and the attack path number, which is the number of attack paths to the asset.

With this, it is possible to derive the response priority in a highly accurate manner from the standpoint of the level of impact, the level of attack feasibility, and the attack path number.

Note that the determination of the risk values and the selection of the largest risk value performed by third priority deriver 23 may also be performed by a threat analysis system. For example, the threat analysis system first performs a threat analysis on the analysis target item, after which vulnerability analysis system 10 performs a vulnerability analysis on the analysis target item. In the threat analysis, the threat analysis system determines the risk values and selects the largest risk value. In the vulnerability analysis performed by vulnerability analysis system 10, third priority deriver 23 determines the risk values and selects the largest risk value. Stated differently, third priority deriver 23 in the present embodiment determines the risk values and selects the largest risk value by performing the same processing as that performed by the threat analysis system. Alternatively, when the threat analysis system determines the risk values and selects the largest risk value in the threat analysis, third priority deriver 23 may obtain, from such threat analysis system, the largest risk value that is obtained by the processing performed by the threat analysis system, without determining the risk values and selecting the largest risk value.

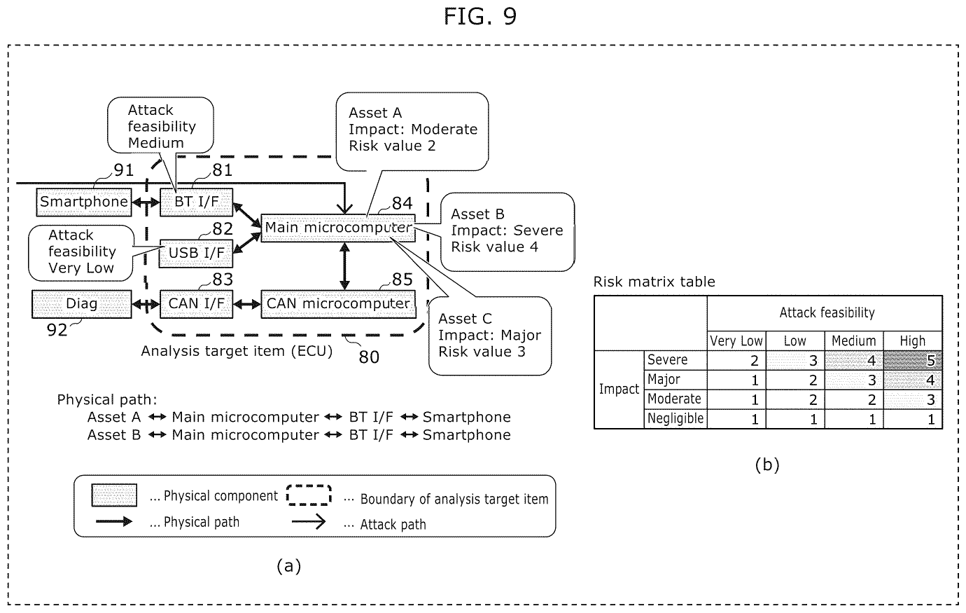

FIG. 9 is a diagram for illustratively describing the determination of risk value and other processing performed by the threat analysis system.

As shown in (a) in FIG. 9, for example, the threat analysis system evaluates the risk value of each of asset A, asset B, and asset C included in analysis target item 80. Asset A, asset B, and asset C are, for example, data items or functions that should be protected in analysis target item 80. Analysis target item 80, which is configured in the form of an ECU mounted on the vehicle, for example, communicates with external devices, such as smartphone 91 and Diag 92, via wireless or wired communication. Note that smartphone 91 is a smartphone, and Diag 92 is a device that diagnoses deficiencies, defects, etc. in the vehicle, that is, a vehicle diagnosis. Such analysis target item 80 includes BT interface 81, USB interface 82, CAN interface 83, main microcomputer 84, and CAN microcomputer 85, which are physical components. BT interface 81, which is also written as BTI/F, is an interface for Bluetooth. USB interface 82, which is also written as USBI/F, is an interface for universal serial bus (USB). CAN interface 83, which is also written as CANI/F, is an interface for CAN. Main microcomputer 84 is a microcomputer that controls analysis target item 80. Main microcomputer 84 includes asset A, asset B, and asset C described above. CAN microcomputer 85 is a microcomputer that performs controls related to the CAN of analysis target item 80. Note that these physical components are hardware components.

Here, a physical present between main microcomputer 84 and each of BT interface 81, USB interface 82, and CAN microcomputer 85. A physical path is also present between BT interface 81 and smartphone 91. A physical path is also present between CAN microcomputer 85 and CAN interface 83, and a physical path is also present between CAN interface 83 and Diag 92. Note that these physical paths are physical connection paths.

Some of the physical components are assigned levels of attack feasibility. For example, BT interface 81 is assigned “Medium” as the level of attack feasibility. USB interface 82 is assigned “VeryLow” as the level of attack feasibility.

In addition, the level of impact on analysis target item 80 exerted by an attack to each of the assets is set to such asset. For example, “Moderate” is set to asset A as the level of impact, “Severe” is set to asset B as the level of impact, and “Major” is set to asset C as the level of impact. Note that a level of impact is also referred to as “degree of impact”.

The threat analysis system determines, for each of asset A, asset B, and asset C, one or more attack paths to such asset. Stated differently, for each of asset A, asset B, and asset C, the threat analysis system determines one or more physical paths, each of which is formed of an arrangement of one or more physical components from an external device leading to such asset.

When smartphone 91 attacks asset A, asset B, and asset C, for example, smartphone 91 is likely to access main microcomputer 84 via BT interface 81 to which the level of attack feasibility “Medium” is assigned. Alternatively, smartphone 91 is likely to access main microcomputer 84 via USB interface 82 to which the level of attack feasibility “Very Low” is assigned. Stated differently, the attack paths to asset A, asset B, and asset C include an attack path via BT interface 81 and an attack path via USB interface 82. For this reason, the threat analysis system determines two attack paths for each of asset A, asset B, and asset C.

For each of the attack paths determined for each of asset A, asset B, and asset C, the threat analysis system determines the risk value, using the level of attack feasibility corresponding to such attack path and the level of impact on such asset, with reference to the risk matrix table shown in (b) in FIG. 9. Stated differently, the threat analysis system determines the risk value for each of the two attack paths to asset A, the risk value for each of the two attack paths to asset B, and the risk value for each of the two attack paths to asset C.

As shown in (b) in FIG. 9, the risk matrix table shows the risk value corresponding to each combination of a level of attack feasibility level and a level of impact. The levels of attack feasibility are classified into “Very Low”, “Low”, “Medium”, and “High”. These levels are listed in descending order. Also, the levels of impact are classified into “Severe”, “Major”, “Moderate”, and “Negligible”. These levels are listed in ascending order.

In the foregoing example, the level of impact on asset A is “Moderate”, the level of impact on asset B is “Severe”, and the level of impact on asset C is “Major”. Also, the level of attack feasibility corresponding to one of the two attack paths is “Medium”, and the level of attack feasibility corresponding to the other of the two attack paths is “Very Low”.

Thus, the threat analysis system refers to the risk matrix table to determine, as a risk value for asset A, the risk value “2”, which corresponds to the combination of the level of attack feasibility “Medium” and the level of impact on asset A “Moderate”. The threat analysis system further determines, as a risk value for asset A, the risk value “1”, which corresponds to the combination of the level of attack feasibility “Very Low” and the level of impact on asset A “Moderate”. The threat analysis system then selects the largest risk value “2” from these risk values “2” and “1”.

Similarly, the threat analysis system refers to the risk matrix table to determine, as a risk value for asset B, the risk value “4”, which corresponds to the combination of the level of attack feasibility “Medium” and the level of impact on asset B “Severe”. The threat analysis system further determines, as a risk value for asset B, the risk value “2”, which corresponds to the combination of the level of attack feasibility “Very Low” and the level of impact on asset B “Severe”. The threat analysis system then selects the largest risk value “4” from these risk values “4” and “2”.

Similarly, the threat analysis system refers to the risk matrix table to determine, as a risk value for asset C, the risk value “3”, which corresponds to the combination of the level of attack feasibility “Medium” and the level of impact on asset C “Major”. The threat analysis system further determines, as a risk value for asset C, the risk value “1”, which corresponds to the combination of the level of attack feasibility “Very Low” and the level of impact on asset C “Major”. The threat analysis system then selects the largest risk value “3” from these risk values “3” and “1”.

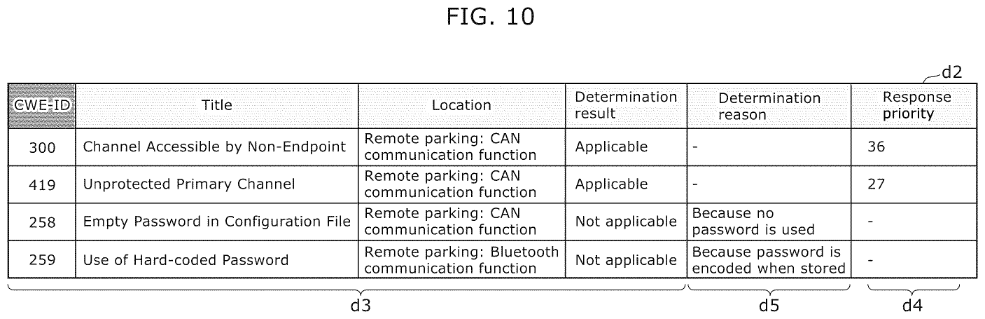

FIG. 10 is a diagram showing an example of analysis result report d2 outputted from outputter 17.

Outputter 17 outputs analysis result report d2 that includes determination result information d3 obtained from applicability determiner 13, reason information d5 obtained from reason deriver 15, and priority information d4 obtained from priority deriver 16. Stated differently, as shown in FIG. 10, analysis result report d2 indicates, for each CWE-ID, the title of the first vulnerability identified by such CWE-ID, and the determination result indicating whether such first vulnerability is applicable to the analysis target item. The titles and determination results are shown in determination result information d3. In an example in FIG. 10, analysis result report d2 indicates, for each CWE-ID, the location of the first vulnerability identified by such CWE-ID. The location is, for example, a function having the first vulnerability (e.g., remote parking function), among the functions included in the analysis target item. Such a location may also be indicated in determination result information d3.

Further, when first vulnerabilities identified by CWE-IDs are not the applicable vulnerabilities, analysis result report d2 indicates, for each of the CWE-IDs, the reason why the first vulnerability is not applicable to the analysis target item, as a determination reason. Such determination reason is indicated in reason information d5. For example, upon obtaining determination result information d3 from applicability determiner 13, reason deriver 15 identifies the characteristic of the first vulnerability “password” on the basis of the details of the title of the first vulnerability indicated in such result information d3. Reason deriver 15 then derives, as the foregoing determination reason, that “password”, which is the characteristic of the first vulnerability, is not used in the “CAN communication function” where the first vulnerability is located, and outputs reason information d5 indicating such determination reason. The determination reason indicated by such reason information d5 is included in analysis result report d2. With this, the reason why the first vulnerability is not applicable to the analysis target item, that is, the reason for non-applicability, is derived as the determination reason. It is thus possible to ensure the reliability of the determination result obtained by applicability determiner 13.

Further, analysis result report d2 indicates, for each CWE-ID, the priority of the mitigation to be taken against the first vulnerability identified by such CWE-ID as the response priority, when such first vulnerability is the applicable vulnerability. This response priority is indicated in priority information d4.

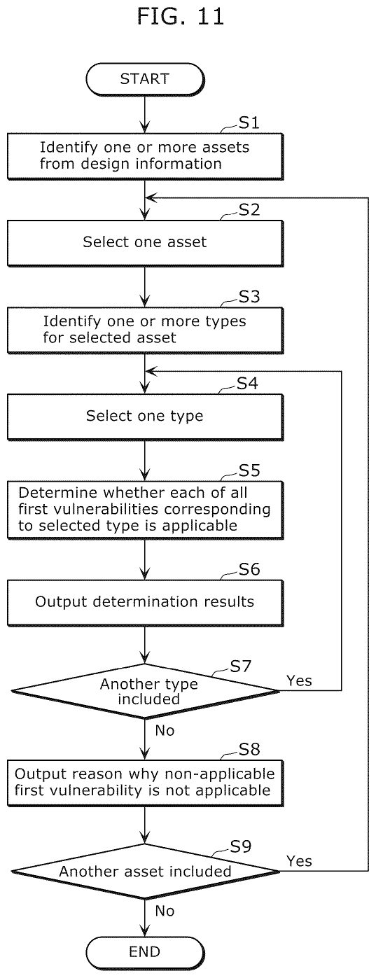

FIG. 11 is a flowchart showing an example of a series of processing operations performed by classification identifier 11, applicability determiner 13, and reason deriver 15.

First, classification identifier 11 identifies one or more assets indicated in design information d1 of the analysis target item (step S1). Classification identifier 11 then selects one asset from such one or more assets (step S2).

Next, classification identifier 11 refers to first classification information 12ad and second classification information 12bd to identify one or more types to which the selected asset belongs (step S3). Note that such one or more types may be the first type and second type described above.

Next, applicability determiner 13 selects one type from the one or more types identified in step S3 (step S4). Applicability determiner 13 then refers to vulnerability management information 14d to search for all of the first vulnerabilities associated with the selected type, and determines whether each of such first vulnerabilities is applicable to the analysis target item (step S5). Further, applicability determiner 13 outputs determination result information d3 indicating the determination results of step S5 (step S6).

Next, applicability determiner 13 determines whether the one or more types identified in step S3 include another type not selected in step S4 (step S7). Here, when determining that another type is included (Yes in step S7), applicability determiner 13 repeats the processes from step S4 for such other type. Meanwhile, when applicability determiner 13 determines that no other type is included (No in step S7), reason deriver 15 outputs the reason for non-applicability for each of the first vulnerabilities not applicable to the analysis target item indicated in determination result information d3 outputted in step S6 (step S8). Stated differently, reason deriver 15 outputs reason information d5.

Subsequently, after the process of step S8 has been performed, classification identifier 11 determines whether the one or more assets indicated in design information d1 of the analysis target item include another asset not selected in step S2 (step S9). When determining that another asset is included (Yes in step S9), classification identifier 11 repeats the processes from step S2 for such other asset. Meanwhile, when determining that no other asset is included (No in step S9), classification identifier 11 ends the processing related to the assets.

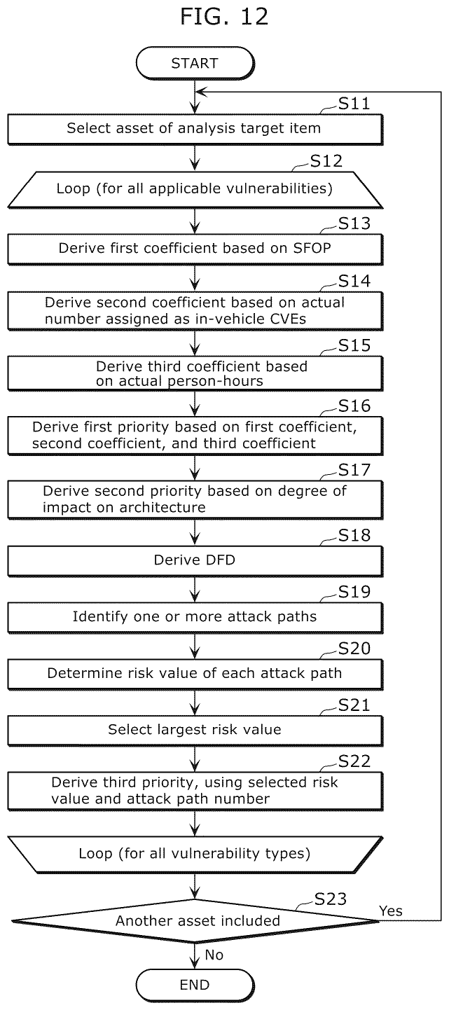

FIG. 12 is a flowchart showing an example of the processing operation performed by priority deriver 16.

First, priority deriver 16 selects one asset from one or more assets indicated in design information d1 (step S11). Priority deriver 16 then executes the loop processing of step S12 for each of all the applicable vulnerabilities corresponding to the asset selected in step S11.

More specifically, first priority deriver 21 derives the first coefficient for the applicable vulnerability on the basis of SFOP (step S13). First priority deriver 21 further derives the second coefficient for the applicable vulnerability on the basis of the actual number assigned as an in-vehicle CVE (step S14). First priority deriver 21 further derives the third coefficient for the applicable vulnerability on the basis of the actual person-hours spent to take the mitigation against such applicable vulnerability (step S15). First priority deriver 21 then derives the first priority of the mitigation to be taken against the applicable vulnerability, on the basis of the first coefficient, the second coefficient, and the third coefficient derived in steps S13 to S15 (step S16).

Next, second priority deriver 22 derives the second priority of the mitigation to be taken against the applicable vulnerability, on the basis of the first priority derived in step S16 and the degree of impact on the architecture (step S17).

Next, third priority deriver 23 derives the DFD of the analysis target item on the basis of, for example, design information d1 (step S18). Third priority deriver 23 then identifies one or more attack paths to the asset selected in step S11 on the basis of such DFD (step S19). Third priority deriver 23 further determines, for each of the attack paths identified in step S19, the risk value of the asset in such attack path (step S20). After that, third priority deriver 23 selects the largest risk value from the risk values of the attack paths determined in step S20 (step S21). Third priority deriver 23 then derives, as the response priority, the third priority of the mitigation to be taken against the applicable vulnerability, using the risk value selected in step S21 and the attack path number, which is the number of attack paths identified in step S19 (step S22). Such response priority as described above is derived for each of all the applicable vulnerabilities corresponding to the asset selected in step S11.

After the loop processing of step S12 has been performed, priority deriver 16 determines whether the one or more assets indicated in design information d1 include another asset not selected in step S11 (step S23). Here, when determining that another asset is included (step S23 Yes), priority deriver 16 repeats the processes from step S11. The other asset is selected in step S11, and the third priority of the mitigation to be taken against each of all the applicable vulnerabilities corresponding to such other asset, that is, the response priority, is derived in the loop processing of step S12. Meanwhile, when priority deriver 16 determines that no other asset is included (step S23 No), the processing of deriving the response priorities ends.

Vulnerability analysis system 10 and the vulnerability analysis method according to one or more aspects of the present disclosure have been described above on the basis of the embodiment, but the present disclosure is not limited to such embodiment. The scope of the present disclosure may also include an embodiment achieved by making various modifications to the foregoing embodiment that can be conceived by those skilled in the art without departing from the essence of the present disclosure.

For example, in the foregoing embodiment, vulnerability analysis system 10 may determine whether a first vulnerability is applicable to the analysis target item, and derive the response priority of the applicable vulnerability, depending on the granularity of an asset indicated in design information d1. Stated differently, the granularity of the asset may be the unit of software component, or may be the detailed module unit or function unit included in the software.

Also, actual CWE number information 24d in the foregoing embodiment indicates the number of vulnerabilities identified by CVE-IDs as the number of second vulnerabilities found in the past, but the second vulnerabilities may be vulnerabilities other than those identified by CVE-IDs. Further, actual CWE number information 24d stored in actual CWE number storage 24 may be updated at regular time intervals. For example, first priority deriver 21 may update actual CWE number information 24d by communicating with a computer located outside of vulnerability analysis system 10 via a communication network. Similarly, first priority deriver 21 may update actual person-hour information 25d stored in actual person-hour storage 25 by communicating with such computer via a communication network.

Also, reason deriver 15 in the foregoing embodiment derives the reason why a first vulnerability is not applicable to the analysis target item, that is, the reason for non-applicability, but the present disclosure is not limited to this. Reason deriver 15 may thus derive other matters. For example, reason deriver 15 may derive that the mitigation has been already taken against the first vulnerability, that other requirements are present that should be prioritized over the mitigation to be taken against the first vulnerability, or that the mitigation against the first vulnerability will be taken in a later process, and may derive the reasons for these matters. Such derivation by reason deriver 15 may be performed with reference to a predefined database.

Also, in the foregoing embodiment, each of the components included in vulnerability analysis system 10 may perform the processing corresponding to such component in response to an input operation performed by a person, or may automatically perform the processing without receiving such input operation. A machine learning model showing the correlation between input and output, for example, may be used in such automatically performed processing.

Note that each of the elements in the foregoing embodiment may be configured in the form of an exclusive hardware product, or may be realized by executing a software program suitable for such element. Each of the elements may be realized by means of a program executing unit, such as a central processing unit (CPU) and a processor, reading and executing the software program recorded on a recording medium such as a hard disk or a semiconductor memory. Here, the software program that realizes the foregoing vulnerability analysis system and others is a computer program for causing a computer to execute the steps in the flowchart shown in FIG. 11 or FIG. 12.

Note that the present disclosure also includes the cases described below.

(1) At least one of the foregoing system or device is, more specifically, a computer system that includes a microprocessor, a ROM, a RAM, a hard disk unit, a display unit, a keyboard, a mouse, etc. The RAM or the hard disk unit stores the computer program. The microprocessor's operating in accordance with the computer program enables at least one of the foregoing system or device to achieve its function. Here, the computer program is configured, using a combination of a plurality of command codes representing instructions given to the computer to achieve a predetermined function.

(2) One or more, or all of the elements included in at least one of the foregoing system or device may be configured in the form of a single system large scale integration (LSI). The system LSI is a super-multifunctional LSI that is manufactured by integrating a plurality of elements onto a single chip. The system LSI is, more specifically, a computer system that is configured by including a microprocessor, a ROM, a RAM, etc. The RAM stores the computer program. The microprocessor's operating in accordance with the computer program enables the system LSI to achieve its function.

(3) One or more, or all of the elements included in at least one of the foregoing system or device may be implemented in the form of an IC card removable from the device or a single module. The IC card or the module is a computer system that includes a microprocessor, a ROM, a RAM, etc. The IC card or the module may include the foregoing super-multifunctional LSI. The microprocessor's operating in accordance with the computer program enables the IC card or the module to achieve its function. Such IC card or the module may be tamper resistant.

(4) The present disclosure may be the method described above. The present disclosure may also be a computer program that enables such method to be implemented by means of a computer, or digital signals that form a computer program.

The present disclosure may be configured by means of recording a computer program or digital signals on a computer-readable recording medium such as a flexible disk, a hard disk, a compact (CD)-ROM, a DVD, a DVD-ROM, a DVD-RAM, a Blu-ray (registered trademark) disc (BD), and a semiconductor memory. The present disclosure may also be digital signals recorded in such recording medium.

The present disclosure may be configured by means of transmitting the computer program or the digital signals via, for example, a telecommunication line, a wireless or wired communication line, a network represented by the Internet, and data broadcasting.

The present disclosure may be implemented by means of transmitting the program or the digital signals recorded on a recording medium or transmitting the program or the digital signals via, for example, a network, thereby enabling another independent computer system to carry out the present disclosure.

### FURTHER INFORMATION ABOUT TECHNICAL BACKGROUND TO THIS APPLICATION

The disclosure of the following patent application including specification, drawings, and claims is incorporated herein by reference in their entirety: Japanese Patent Application No. 2024-039485 filed on Mar. 13, 2024.

### INDUSTRIAL APPLICABILITY

The vulnerability analysis system of the present disclosure is applicable for use, for example, as a device or a system for analyzing a vulnerability of a program embedded in, for example, a vehicle.

1. A vulnerability analysis system comprising:
memory that stores classification information indicating types of assets in a vehicle on an asset-by-asset basis; and
processor connected to the memory;
wherein the processor executes:
classification identifying including obtaining design information indicating an asset included in an analysis target item, and referring to the classification information to identify a type of the asset indicated in the design information;
determining applicability as to whether each of one or more first vulnerabilities preliminarily associated with the type identified is applicable to the analysis target item; and
outputting an analysis result report indicating a determination result obtained in the determining of the applicability, and
the types indicated in the classification information include one or more in-vehicle security-related types.

2. The vulnerability analysis system according to claim 1,
wherein the memory includes:
first memory that stores first classification information associating each of the one or more in-vehicle security-related types with one or more assets classified into the in-vehicle security-related type; and
second memory that stores second classification information associating each of one or more security-related types not limited to in-vehicle security with one or more assets classified into the security-related type.

3. The vulnerability analysis system according to claim 1,
wherein the processor further executes:
deriving, for each applicable vulnerability, a priority of a mitigation to be taken against the applicable vulnerability as a response priority, the applicable vulnerability being one of the one or more first vulnerabilities that has been determined to be applicable to the analysis target item.

4. The vulnerability analysis system according to claim 3,
wherein the processor:
in the deriving of the priority, deriving the response priority of the applicable vulnerability, using at least one of:
(a) an impact of the applicable vulnerability on traveling of the vehicle that includes the analysis target item;
(b) an actual number of second vulnerabilities found in a plurality of vehicles in past, the second vulnerabilities belonging to the applicable vulnerability; or
(c) an actual person-hour spent to take the mitigation against the applicable vulnerability in past.

5. The vulnerability analysis system according to claim 3,
wherein the processor:
in the deriving of the priority, deriving the response priority of the applicable vulnerability, using a degree of impact that is a magnitude of an impact of the asset on an architecture, the asset being included in the analysis target item.

6. The vulnerability analysis system according to claim 3,
wherein the processor:
in the deriving of the priority, deriving the response priority of the applicable vulnerability, using a level of impact of an attack to the asset on the analysis target item, a level of attack feasibility that is feasibility of the attack to the asset, and a total number of attack paths to the asset.

7. The vulnerability analysis system according to claim 1,
wherein the processor further executes:
deriving a reason why a first vulnerability determined not to be applicable to the analysis target item, among the one or more first vulnerabilities, is not applicable to the analysis target item.

8. A vulnerability analysis method performed by a computer, the vulnerability analysis method comprising:
obtaining design information indicating an asset included in an analysis target item;
referring to classification information indicating types of assets in a vehicle on an asset-by-asset basis to identify a type of the asset indicated in the design information;
determining whether each of one or more first vulnerabilities preliminarily associated with the type identified is applicable to the analysis target item; and
outputting an analysis result report indicating a determination result on each of the one or more first vulnerabilities,
wherein the types indicated in the classification information include one or more in-vehicle security-related types.
